(19) United States
(12) Patent Application Publication
(10) Pub. No.: US 2023/0202328 A1
(43) Pub. Date: Jun. 29, 2023

(54) VOLTAGE OPTIMIZATION FOR ELECTRIC VEHICLE CHARGING INFRASTRUCTURE

(71) Applicant: Rivian IP Holdings, LLC, Plymouth, MI (US)

(72) Inventor: Alex Yang, Redwood City, CA (US)

(21) Appl. No.: 17/564,899

(22) Filed: Dec. 29, 2021

(51) Int. Cl. B60L 53/62; B60L 53/66; H02J 7/00

(52) U.S. Cl. CPC B60L 53/62; B60L 53/66; H02J 7/00712

(57) ABSTRACT

Disclosed embodiments include systems to adjust a voltage output of a transformer responsive to voltage data received from sensors. In an illustrative embodiment, a system includes a voltage sensor system configured to collect voltage data measurable between at least one transformer system and a battery charging system, the battery charging system electrically couplable to a charging device, and the charging device configured to receive electrical power from the at least one transformer system via a power cable; a transceiver configured to receive the voltage data from the voltage sensor system and communicate the voltage data to the at least one transformer system; and a voltage compensator configured to receive the voltage data from the transceiver and adjust a voltage output of the transformer system responsive to the voltage data to reduce a voltage drop between the at least one transformer system and the battery charging system.

### INTRODUCTION

Recharging a battery system, such as a battery system used in an electrically-powered vehicle, may take time. Particularly when the electrically-powered vehicle is charging at a public charging station while on a long trip or when one is away from one's home or business, it is desirable to minimize the time required for charging. However, voltage fluctuations on a power grid from which a charging device draws power can cause voltage drops that may reduce charging speeds and, thus, result in a longer charging time.

The statements in this section merely provide background information related to the present disclosure and may not constitute prior art.

### SUMMARY

Disclosed embodiments include systems and methods to adjust a voltage output of a transformer responsive to voltage data received from sensors between the transformer system and a battery charging system.

In an illustrative embodiment, a system includes a voltage sensor system configured to collect voltage data measurable between at least one transformer system and a battery charging system, the battery charging system electrically couplable to a charging device, and the charging device configured to receive electrical power from the at least one transformer system via a power cable; a transceiver configured to receive the voltage data from the voltage sensor system and communicate the voltage data to the at least one transformer system; and a voltage compensator configured to receive the voltage data from the transceiver and adjust a voltage output of the transformer system responsive to the voltage data to reduce a voltage drop between the at least one transformer system and the battery charging system.

In another illustrative embodiment, a system includes: a charging device electrically couplable with a battery charging system of a vehicle and configured to receive electrical power from at least one transformer system via a power cable and provide charging power to the on-board charging system; a voltage sensor system configured to collect voltage data measurable between the at least one transformer system and the battery charging system; a transceiver configured to receive the voltage data from the voltage sensor system and communicate the voltage data to the at least one transformer system; and a voltage compensator configured to receive the voltage data from the transceiver and adjust a voltage output of the at least one transformer system responsive to the voltage data to reduce a voltage drop between the at least one transformer system and the battery charging system.

In another illustrative embodiment, a method includes: collecting voltage data measurable between a transformer and a battery charging system coupled to a charging device, wherein the transformer is coupled to the charging device via a power cable; communicating the voltage data to at least one transformer system that includes the transformer; and based on the voltage data, adjusting a voltage output of the at least one transformer system to reduce a voltage drop between the at least one transformer system and the battery charging system.

Further features, advantages, and areas of applicability will become apparent from the description provided herein. It will be appreciated that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIGS. 1 and 2 are block diagrams in partial schematic form of a voltage sensor system and a voltage compensator for adjusting a voltage output of a transformer system;

FIGS. 3-5 are block diagrams in partial schematic form of the voltage sensor system of FIGS. 1 and 2 reporting voltage data using wired and/or wireless communications;

FIGS. 6A, 6B, 7A, and 7B are block diagrams of a voltage compensator controller for adjusting the output voltage of a transmission system;

FIG. 8 is a block diagram of an illustrative computing system that may be used as the voltage compensator controller of FIGS. 6A and 6B; and

FIG. 9 is a flow chart of an illustrative method for adjusting the voltage output of the transformer system responsive to voltage data received from sensors between the transformer and a battery charging system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

By way of a non-limiting introduction and overview, various disclosed embodiments include systems and methods to adjust a voltage output of a transformer responsive to voltage data received from sensors between the transformer system and a battery charging system. In various embodiments, a transformer system may be responsive to voltage data received from sensors between the transformer system and a battery charging system. To account for voltage drops between a power grid and the battery charging system, the voltage output of the transformer system may be adjusted to account for the voltage drops and improve charging efficiency. Given by way of non-limiting example and still by way of overview, an illustrative system includes a voltage sensor system configured to collect voltage data including a plurality of voltage levels measurable between a transformer system and a battery charging system electrically couplable to a charging device configured to receive electrical power from the transformer system via a power cable; a transceiver configured to receive the voltage data from the voltage sensor system and communicate the voltage data to the transformer system; and a voltage compensator configured to receive the voltage data from the transceiver and adjust a voltage output of the transformer system responsive to the voltage data to reduce a voltage drop between the transformer system and the battery charging system.

Now that a general overview has been given, details of various embodiments will be explained by way of non-limiting examples given by way of illustration only and not of limitation.

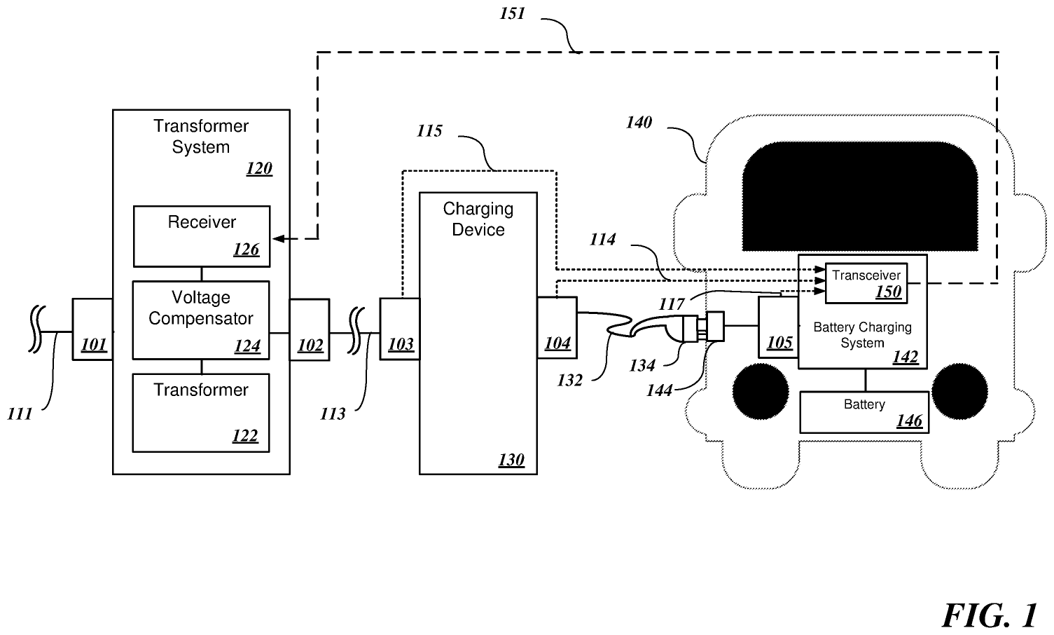

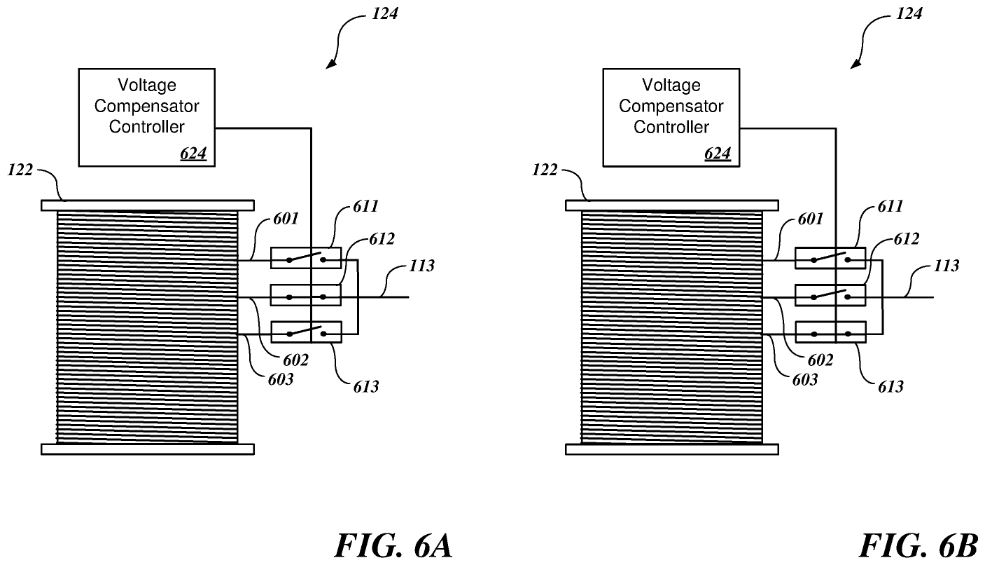

Referring to FIG. 1, in various embodiments, a voltage sensor system includes sensors 101-105 configured to measure voltages between a power line 111 of a power grid (not shown) and a battery charging system 142. In various embodiments, the power line 111 is coupled to a transformer system 120 that includes a transformer 122 that may be tapped at different points by a voltage compensator 124, as described below with reference to FIGS. 6A and 6B.

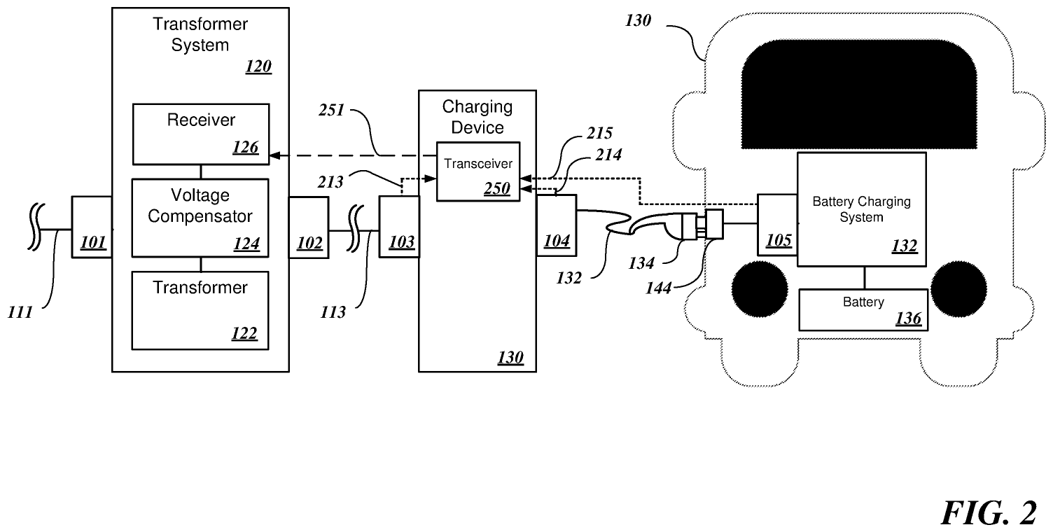

In various embodiments, the voltage compensator 124 adjusts the voltage output of the transformer 122 in response to voltage data received at a receiver 126 from one or more of the sensors 101-105. A voltage output of the transformer system 120 is provided by a cable 113 to a charging device 130. The charging device 130 is couplable via a charging cable 132 and an associated charging coupler 134 to an input coupler 144 of the battery charging system 142. The battery charging system 142 provides power to charge a battery 146. In the example of FIGS. 1 and 2, the battery charging system 142 and the battery 146 are associated with an electrically-powered vehicle 140. However, it will be appreciated that the battery charging system 142 and the battery 146 could be associated with other systems.

In various embodiments, the sensors 101-105 of the voltage sensor system measure voltage data at points between the transformer system 120 and an output the charging device 130. In various embodiments, the voltage sensor system includes a power line sensor 101 and a transformer output sensor 102 that may be compared by the voltage compensator 124 with other voltage data to determine voltage drops between the power line 111 and the battery charging system 142. In various embodiments, the voltage sensor system includes a charging device input sensor 103 and a charging device output sensor 104 to measure the input and output voltages of the charging device 130, respectively. In various embodiments, the voltage sensor system includes a battery charging sensor 105 that measures a charging voltage applied at the input of the battery charging system 142.

In various embodiments, voltage data collected by the voltage sensor system, such as data collected by the charging device input sensor 103, the charging device output sensor 104, and the battery charging sensor 105, are communicated to the receiver 126 coupled with the voltage compensator 124. In various embodiments, the voltage data may be provided to a transceiver that collects the voltage data and communicates the voltage data to the receiver 126.

Referring specifically to FIG. 1, in various embodiments, a charging device voltage input signal 115 generated by the charging device input sensor 103, a charging device voltage output signal 114 generated by the charging device output sensor 104, and a battery charging voltage input signal 117 generated by the battery charging sensor 105 are provided to a transceiver 150 associated with the battery charging system 142. The transceiver 150 communicates a voltage data signal 151 including the voltage data represented by signals 113, 115, and 117 to the receiver 126. Based on potential voltage drop data represented in the voltage data signal 151, the voltage compensator 124 identifies a selected voltage to be generated by the transformer system 120 to reduce potential voltage drops. In various embodiments, the voltage compensator 124 may also include voltage data collected from the power line sensor 101 and the transformer output sensor 102 in reducing the potential voltage drops.

Referring additionally to FIG. 2, in various embodiments, a charging device voltage input signal 213 generated by the charging device input sensor 103, a charging device voltage output signal 214 generated by the charging device output sensor 104, and a battery charging voltage input signal 215 generated by the battery charging sensor 105 are provided to a transceiver 250 associated with the charging device 130. Similar to the example of FIG. 1, the transceiver 250 communicates a voltage data signal 251 including the voltage data represented by signals 213-215 to the receiver 126. Based on potential voltage drop data represented in the voltage data signal 251, the voltage compensator 124 identifies a selected voltage to be generated by the transformer system 120 to reduce potential voltage drops. In various embodiments, the voltage compensator 124 may also include voltage data collected from the power line sensor 101 and the transformer output sensor 102 in reducing the potential voltage drops.

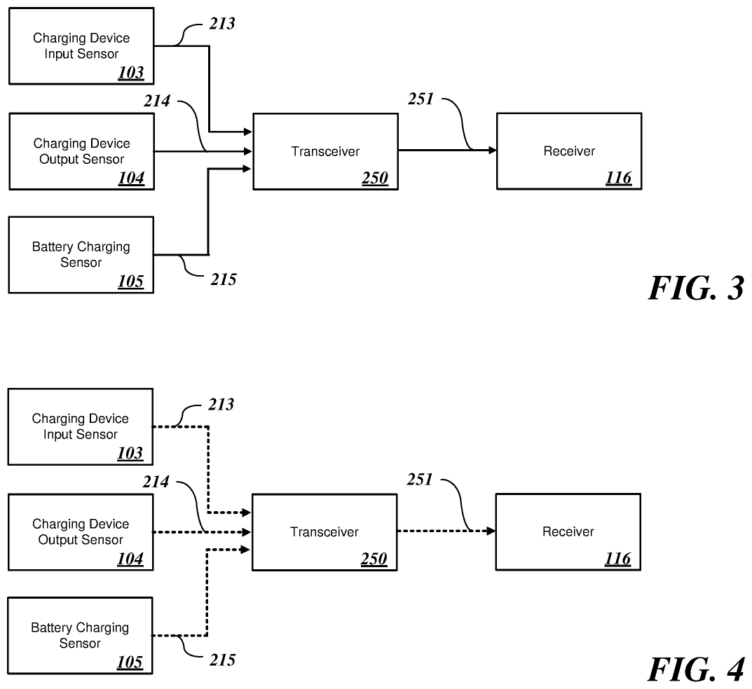

In various embodiments, the voltage data is communicated to the transceiver 150 (FIG. 1) or the transceiver 250 (FIG. 2) and then communicated to the receiver 126 of the transformer system 110 using wired communications, wireless communications, or a combination of wired and wireless communications. Referring additionally to FIG. 3, taking the example of a transceiver 250 associated with the charging device 120 (FIGS. 1 and 2), all of the charging device voltage input signal 213, the charging device voltage output signal 214, and the battery charging voltage input signal 215 may be communicated to the transceiver 250 using wired communications. (The use of wired communications is depicted by the signals 213-215 and 251 being represented with solid lines). In various embodiments, the charging device voltage input signal 213 and the charging device voltage output signal 214 may be communicated by dedicated communications lines. In various embodiments, the battery charging voltage input signal 215 may be communicated via a signal line included in the charging cable 132 and the couplers 134 and 134. In various embodiments, the battery charging voltage input signal 215 may be modulated as a secondary or “piggyback” signal on conductors that provide electric power to the battery charging system 152, just as Powerline networking devices communicate data signals over 110 volt AC power lines. The voltage data signal 251 sent by the transceiver 250 to the receiver 126 may be sent via a telephone line or another available wired connection between the transceiver 250 and the receiver 126.

Referring additionally to FIG. 4, in various embodiments, all of the charging device voltage input signal 213, the charging device voltage output signal 214, and the battery charging voltage input signal 215 may be communicated to the transceiver 250 using wireless communications. The use of wireless communications is depicted by the signals 213-215 and 251 being represented with dotted lines. The charging device input sensor 103, the charging output sensor 104, and the battery charging sensor 105 may communicate with the transceiver 250, for example, by using Bluetooth communications, by IEEE 802.01-type Wi-Fi communications, or another wireless communications medium. The transceiver 250 may communicate wirelessly with the receiver 126, for example, by using wireless or cellular communications.

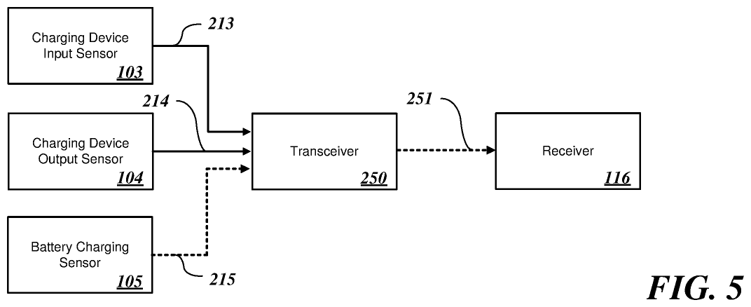

Referring additionally to FIG. 5, in various embodiments, a combination of both wired and wireless communications may be used to communicate the voltage data. Again using the example of the transceiver 250 associated with the charging device 120, the charging device input sensor 103 and the charging device output sensor 104 may communicate with the transceiver 250 using dedicated, wired communications lines as the charging device input sensor 103 and the charging device output sensor 104 are situated within the charging device 120 or in a stationary location nearby. On the other hand, the battery charging sensor 105 may communicate wirelessly with the transceiver, using Bluetooth, Wi-Fi, or other wireless communications, since the battery charging sensor 105 is physically located in a separate device, i.e., the vehicle 140. The transceiver 250 may communicate with the receiver 126 using wireless communications, as previously described with reference to FIG. 4, or with wired communications.

Referring additionally to FIGS. 6A and 6B, the voltage compensator 124 may be used to select the output voltage of the transformer 122. In various embodiments, the voltage compensator may adjust voltage drops reflected in the voltage data (FIGS. 1 and 2) by selectively tapping the transformer 122 at different points to adjust the output voltage. For the sake of example, the transformer 122 of FIGS. 6A and 6B includes three taps 601-603, each of which may result in a different output voltage. It will be appreciated that the selection of three taps 601-603 is just for the sake of example; in various embodiments, any number of taps may be used.

In various embodiments, the taps are selectable by selectively operating electromechanical selectors 611-613, such as relays, that are associated with each of the taps 601-603 respectively. The electromechanical selectors 611-613 are controlled by a voltage compensator controller 624. The voltage compensator controller 624 receives the voltage data from the receiver 126 and, based on the voltage data, selects which of the taps 601-603 should be connected to the cable 113 that is coupled to the charging device 120. Upon identifying which of the taps 601-603 should be used, the voltage compensator controller 624 activates a corresponding electromechanical selector of the electromechanical selectors 611-613. In the example of FIG. 6A, the electromechanical selector 612 is activated to couple the tap 602 to the output cable 113.

The voltage compensator 124 may be operated continuously to respond to conditions resulting in changing voltage drops. Referring additionally to FIG. 6B, for example, based on a determination by the voltage compensator controller 624, a third tap 603 is selected to account for identified voltage drops. Accordingly, the voltage compensator controller 624 opens the previously-closed electromechanical selector 612 to decouple the second tap 602 from the output cable 613 and closes the electromechanical selector 613 to couple the third tap 603 to the output cable 113.

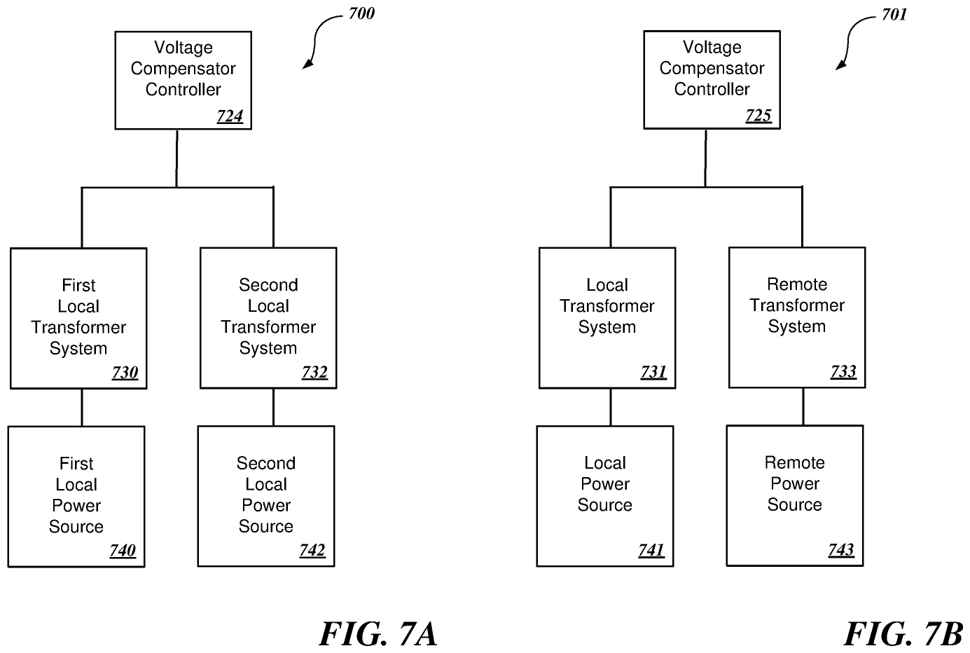

Referring additionally to FIGS. 7A and 7B, it will be appreciated that it may be desirable for a voltage compensator controller, like the voltage compensator controller 624 of FIGS. 6A and 6B, to communicate with multiple transformer systems. Referring to FIG. 7A, a system 700 may include multiple local sources of power, including a first local power source 740 and a second local power source 742. It may be particularly desirable to have multiple local power sources 740 and 742 at locations where many charging stations might be provided, such as industrial buildings, office buildings, or locations where it might be desirable to provide charging for multiple vehicles. Accordingly, a voltage compensation controller 724 may be configured to communicate with a first local transformer system 730 associated with the first local power source 740 and with a second local transformer system 732 associated with the second local power source 742. The voltage compensation controller 724 thus is able to adjust the voltage output of each of the transformer systems 730 and 732 to avoid voltage drops from each of the local power sources 740 and 742, respectively. The power compensation controller 724 may communicate with each of the local power sources 740 and 742 and the transformer systems 730 and 732 as previously described with reference to FIGS. 1-6B.

Referring to FIG. 7B, a system 701 may include multiple sources of power, including a local power source 741 and a remote power source 743, such as a power plant or an electrical substation. Accordingly, a voltage compensation controller 725 may be configured to communicate with a local transformer system 731 associated with the local power source 741 and with a remote transformer system 733 associated with the remote power source 743 to adjust the voltage output of each of the transformer systems 731 and 733, respectively. In various embodiments, the voltage compensator controller 725 also may communicate with generators, reclosers, or other types of relays included in the remote power source 743 to adjust voltage output. For remote systems, the voltage compensation controller 725 may communicate using existing utility interfaces by using DNP3, SCADA, or OPENADR protocols across the Internet or via direct or other custom end-to-end communications with a utility that operates the remote power source 743.

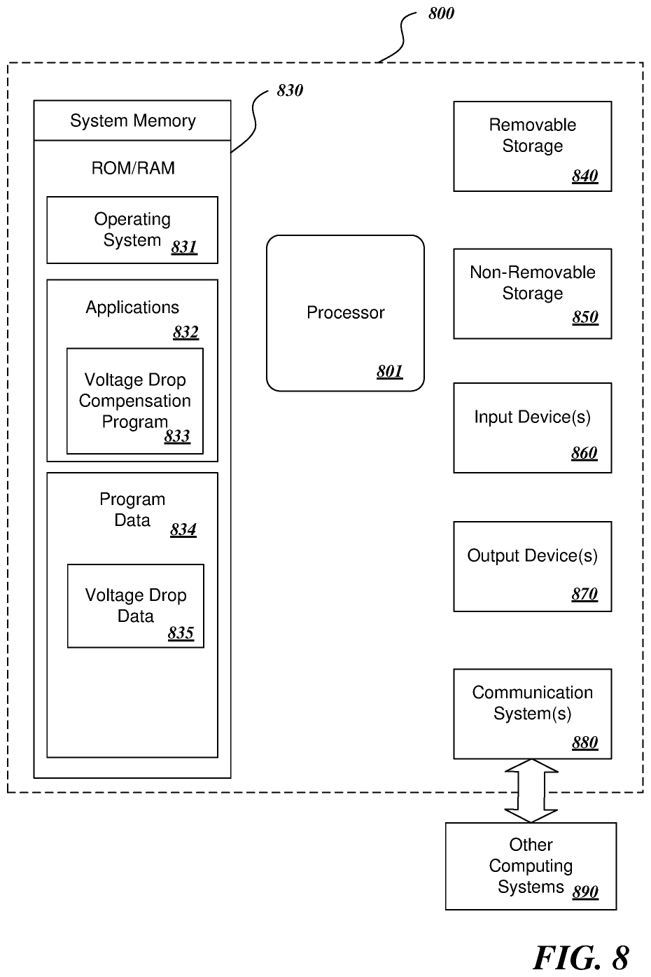

Referring additionally to FIG. 8 and given by way of example only and not of limitation, an illustrative computing device 800 may be used as the voltage compensator controller 624. In various embodiments, the computing device 800 typically includes at least one processing unit 820 and a system memory 830. Depending on the configuration and type of computing device, the system memory 830 may include volatile memory, such as random-access memory (“RAM”), non-volatile memory, such as read-only memory (“ROM”), flash memory, and the like, or a combination of volatile memory and non-volatile memory. The system memory 830 typically maintains an operating system 832, one or more applications 832, and program data 834 to provide instructions to the processing unit 820. The operating system 832 may include any number of operating systems executable on desktop or portable devices including, but not limited to, Linux, Microsoft Windows®, Apple iOS®, or Android®, or a proprietary operating system. The applications 832 may include a voltage drop compensation program 833 that evaluates the voltage data provided by the sensor system as described with reference to FIGS. 1 and 2 and, as described with reference to FIGS. 6A and 6B, adjust a voltage output of the transformer 122 to account for detected voltage drops. The program data 834 may include voltage drop data 835, such as tables or formulae usable to determine how to adjust the output of the transformer 122 to account for detected voltage drops.

The computing device 800 may also have additional features or functionality. For example, the computing device 800 may also include additional data storage devices (removable and/or non-removable) such as, for example, magnetic disks, optical disks, tape, or flash memory. Such additional storage devices are illustrated in FIG. 8 by removable storage 840 and non-removable storage 850. Computer storage media may include volatile and non-volatile, removable and non-removable media implemented in any method or technology for storage of information, such as computer-readable instructions, data structures, program modules or other data. The system memory 830, the removable storage 840, and the non-removable storage 850 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic disk storage or other magnetic storage devices, or any other medium which can be used to store the desired information and which can be accessed by the computing device 800. Any such computer storage media may be part of the computing device 800.

The computing device 800 may also have input device(s) 860 such as a keyboard, stylus, voice input device, touchscreen input device, etc. Output device(s) 870 such as a display, speakers, short-range transceivers such as a Bluetooth transceiver, etc., may also be included. The computing device 800 also may include one or more communication systems 880, such as the communications system 418 and 458 (FIG. 4) that allow the computing device 800 to communicate with other computing systems 890. The computing device 800 may be configured to with other computing systems 890 to update the applications 832 or program data 834 or to collect program data 834 for analysis. The communication system 880 may include systems for wired or wireless communications. Available forms of communication media typically carry computer-readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

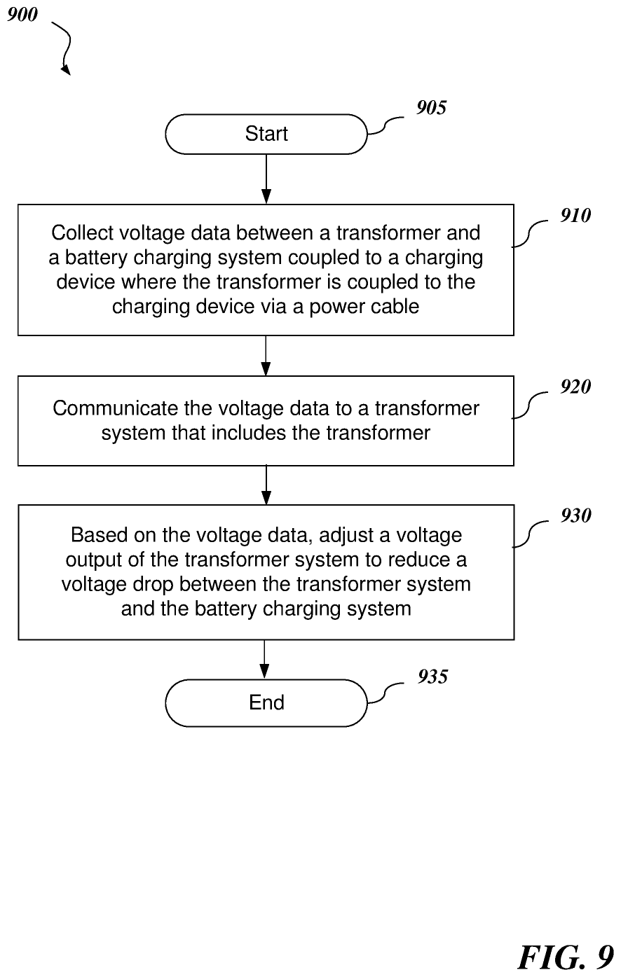

Referring to FIG. 9, an illustrative method 900 is provided for adjusting a voltage output of a transformer responsive to voltage data received from sensors between the transformer system and a battery charging system. The method 900 starts at a block 905. At a block 910, voltage data is collected including voltage levels measurable between a transformer and a battery charging system coupled to a charging device where the transformer is coupled to the charging device via a power cable. At a block 920, the voltage data is communicated to a transformer system that includes the transformer. At a block 930, based on the voltage data, a voltage output of the transformer system is adjusted to reduce a voltage drop between the transformer system and the battery charging system. The method 900 ends at a block 935.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

What is claimed is:

1. A system comprising:
a voltage sensor system configured to collect voltage data measurable between at least one transformer system and a battery charging system, the battery charging system electrically couplable to a charging device, and the charging device configured to receive electrical power from the at least one transformer system via a power cable;
a transceiver configured to receive the voltage data from the voltage sensor system and communicate the voltage data to the at least one transformer system; and
a voltage compensator configured to receive the voltage data from the transceiver and adjust a voltage output of the transformer system responsive to the voltage data to reduce a voltage drop between the at least one transformer system and the battery charging system.

2. The system of claim 1, wherein the voltage sensor system includes at least one charging device sensor chosen from a charging device input sensor configured to measure an input voltage presented at an input of the charging device, where the voltage data includes the input voltage, and a charging device output sensor configured to measure an output voltage presented at an output of the charging device, where the voltage data includes the output voltage.

3. The system of claim 2, wherein the voltage sensor system includes a battery charging sensor configured to measure a charging voltage presented at the battery charging system and wherein the voltage data includes the charging voltage.

4. The system of claim 3, wherein the transceiver includes at least one device chosen from a charging device transceiver associated with the charging device and a battery charging transceiver associated with the battery charging system.

5. The system of claim 1, wherein the transceiver is configured to receive the voltage data from the voltage sensor system using a wireless communications system.

6. The system of claim 1, wherein at least one transformer is associated with the at least one transformer system, the at least one transformer including a plurality of transformer coil taps presenting a plurality of voltage outputs and wherein the voltage compensator includes a voltage compensator controller configured to receive the voltage data from the transceiver, determine a selected voltage output from among the plurality of voltage outputs to reduce the voltage drop, and electrically couple a corresponding tap of the plurality of transformer coil taps to the power cable.

7. The system of claim 6, wherein the voltage compensator controller includes an electro-mechanical selector configured to electrically couple the corresponding tap to the power cable to provide the selected voltage output.

8. A vehicle charging system comprising:
a charging device electrically couplable with a battery charging system of a vehicle and configured to receive electrical power from at least one transformer system via a power cable and provide charging power to the on-board charging system;
a voltage sensor system configured to collect voltage data measurable between the at least one transformer system and the battery charging system;
a transceiver configured to receive the voltage data from the voltage sensor system and communicate the voltage data to the at least one transformer system; and
a voltage compensator configured to receive the voltage data from the transceiver and adjust a voltage output of the at least one transformer system responsive to the voltage data to reduce a voltage drop between the at least one transformer system and the battery charging system.

9. The vehicle charging system of claim 8, wherein the voltage sensor system includes at least one charging device sensor chosen from a charging device input sensor configured to measure an input voltage presented at an input of the charging device, where the voltage data includes the input voltage, and a charging device output sensor configured to measure an output voltage presented at an output of the charging device, where the voltage data includes the output voltage.

10. The vehicle charging system of claim 9, wherein the voltage sensor system includes a vehicle sensor configured to measure a charging voltage presented at the battery charging system of the vehicle and wherein the voltage data includes the charging voltage.

11. The vehicle charging system of claim 10, wherein the transceiver includes at least one device chosen from a charging device transceiver associated with the charging device and a battery transceiver associated with the battery charging system.

12. The vehicle charging system of claim 8, wherein the transceiver is configured to receive the voltage data from the voltage sensor system using a wireless communications system.

13. The vehicle charging system of claim 8, wherein at least one transformer is associated with the at least one transformer system, the at least one transformer including a plurality of transformer coil taps presenting a plurality of voltage outputs and wherein the voltage compensator includes a voltage compensator controller configured to receive the voltage data from the transceiver, determine a selected voltage output from among the plurality of voltage outputs to reduce the voltage drop, and electrically couple a corresponding tap of the plurality of transformer coil taps to the power cable.

14. The vehicle charging system of claim 13, wherein the voltage compensator controller includes an electro-mechanical selector configured to electrically couple the corresponding tap to provide the selected voltage output.

15. A method comprising:
collecting voltage data measurable between a transformer and a battery charging system coupled to a charging device, wherein the transformer is coupled to the charging device via a power cable;
communicating the voltage data to at least one transformer system that includes the transformer; and
based on the voltage data, adjusting a voltage output of the at least one transformer system to reduce a voltage drop between the at least one transformer system and the battery charging system.

16. The method of claim 15, further comprising:
measuring an input voltage presented at an input of the charging device; and
measuring an output voltage presented at an output of the charging device, wherein the input voltage and the output voltage are included in the voltage data

17. The method of claim 16, further comprising measuring a charging voltage received at the battery charging system, wherein the charging voltage is included in the voltage data.

18. The method of claim 15, further comprising communicating the voltage data using wireless communications.

19. The method of claim 15, further comprising adjusting the voltage output of the at least one transformer system by:
responsive to the voltage data, determining a selected voltage output to reduce the voltage drop; and
tapping a transformer coil of at least one transformer associated with the at least one transformer system at one of a plurality of transformer coil taps presenting a plurality of output voltages to select a tap presenting the selected voltage; and
coupling the selected tap to the power cable.

20. The method of claim 19, further comprising coupling the selected tap to the power cable using at least one process chosen from electro-mechanically coupling the selected tap to the power cable and electrically coupling the tap to the power cable.
